(19) United States
(12) Patent Application Publication
(10) Pub. No.: US 2002/0017341 A1
(43) Pub. Date: Feb. 14, 2002

(54) IRON-BASED SOFT MAGNETIC THIN FILM ALLOY

(76) Inventors: HI JUNG KIM, SEOUL (KR); SUK HEE HAN, SEOUL (KR); JONGRYOUL KIM, SEOUL (KR); JAE YONG SONG, SEOUL (KR)

Correspondence Address: SCULLY SCOTT MURPHY & PRESSER, 400 GARDEN CITY PLAZA, GARDEN CITY, NY, 11530

(21) Appl. No.: 09/225,808

(22) Filed: Jan. 5, 1999

(30) Foreign Application Priority Data
Apr. 23, 1998 (KR) 14602/1998

(51) Int. Cl. H01F 1/04; C22C 38/00

(52) U.S. Cl. 148/306; 420/128

(57) ABSTRACT

Improved Fe—Hf—C—N and Fe—Hf—N materials and preparation methods thereof are disclosed. Such materials possess a high saturation magnetic flux density and an excellent soft magnetic property at a high frequencies of more than tens of MHz, without requiring an additional heat treatment, while avoiding an amorphous phenomenon therein and increasing grain energy. An iron-based soft magnetic thin film alloy has an empirical formula of FeₓHf_{y}C_{z}Nᵥ (where, x, y, z, and v respectively denote atomic %, 68≦x≦85, 4≦y≦10, 0≦z≦12, 3≦v≦20, 15≦y+z+v≦32, and x+y+z+v=100), and its fine structure is formed of nano size crystalline grains including nitrides or carbides of α-Fe and Hf. The method for preparation of an iron-based soft magnetic thin film alloy having a hyperfine crystalline grain architecture in a deposited state without requiring a heat treatment process, comprises the steps of disposing Hf, nitrides and carbides of Hf, and C on a pure iron alloy, an Fe—Hf alloy, or Fe—Hf—C alloy target, performing a deposition by adjusting a cooling rate and particle energy under an inert gas atmosphere or an atmosphere containing C or N, so as to obtain a nano size hyperfine crystalline grain architecture, wherein as a deposition condition an input power density of 4˜8 W/cm², under an N₂ partial pressure of 2˜20%, and a ([C]+[N])/[Hf] composition ratio of 1.5˜2.5 are maintained.

### BACKGROUND OF THE INVENTION

1. Field of the Invention

The present invention relates to an iron-based soft magnetic thin film material, having Fe—Hf binary system as its basic composition, and more particularly to an improved Fe—Hf—C—N and Fe—Hf—N thin film alloys having excellent soft magnetic properties including a high saturation magnetic flux density, a high magnetic permeability and a heat resistance in a high frequency zone up into the hundreds of MHz bands.

2. Description of the Prior Art

Recently, as information industry devices are applied to higher frequency and higher integration, their respective electronic parts continuously trend toward becoming more miniaturized and surface-mounted. A magnetic head adopted in computers and information recording devices, however, faces limitation in its multifunctioning and realizing a higher frequency capability, on account of the limited properties of soft magnetic materials employed as magnetic cores. In particular, magnetic devices applicable to various electronic parts, such as transformers and inductors, still employ core types with a sizable volume, thereby making it further difficult to realize their technological development. Accordingly, a soft magnetic thin film material having an excellent high frequency property has been long required in the related art so as to realize a surface-mountability and miniaturization of such magnetic devices.

Typical conventionally employed soft magnetic materials include an Fe—Al—Si Sendust alloy, a Ni—Fe Permalloy alloy and a Co amorphous alloy. Such materials, however, exhibit low saturation magnetic flux densities and poor high frequency properties, whereby their application to high frequency thin film magnetic devices also faces limitation.

In Korea Patent Publication No. 96-4664, the present inventors have disclosed a new Fe—Hf—C—N thin film having an excellent soft magnetic property together with a high saturation magnetic flux density in the MHz band.

However, such a thin film material has to undergo a heat treatment so as to obtain a good soft magnetic property and a high saturation magnetic flux density. Here, being subjected to such heat treatment can lead to deterioration of parts by influencing thin films or devices other than magnetic thin films, as well as confining the fabrication process of an entire magnetic device. Further, the thin film material causes an increased eddy current flow in a frequency band of more than 10 MHz, thereby abruptly decreasing an effective magnetic permeability.

Presently, there has been developed a high frequency soft magnetic thin film having an architecture of metallic material mixed of ceramic phase. Its effective permeability, however, remains in the hundreds, so that its applicability is still poor. In a high frequency band of more than tens of MHz there is employed a Mn—Zn ferrite, which also exhibits a low saturation magnetic flux density, thereby making it difficult to realize a highly functional device therewith.

### SUMMARY OF THE INVENTION

The present invention is directed to overcoming the disadvantages of the conventional soft magnetic thin films.

Accordingly, it is an object of the present invention to provide improved Fe—Hf—C—N and Fe—Hf—N materials and production process therefor, which materials respectively can exhibit a high saturation magnetic flux density and an excellent soft magnetic property in a high frequency region of more than tens of MHz, without requiring additional heat treatments.

To achieve the above-described object, there is provided an iron-based soft magnetic thin film alloy according to the present invention, having an empirical formula of FeₓHf_{y}C_{z}Nᵥ (here, x, y, z, and v respectively denote atomic %, 68≦x≦85, 4≦y≦10, 0≦z≦12, 3≦v≦20, 15≦y+z+v≦32, and x+y+z+v=100), wherein a fine structure thereof is formed of nano size crystalline grains including nitrides or carbides of α-Fe and Hf.

Further, to achieve the above-described object, there is provided a method for preparation of an iron-based soft magnetic thin film alloy having a hyperfine crystalline grain architecture in a deposited state without requiring a heat treatment process, comprising the steps of: disposing Hf, nitrides and carbides of Hf, and C on a pure iron alloy, an Fe—Hf alloy, or Fe—Hf—C alloy target; performing a deposition by adjusting a cooling rate and particle energy under an inert gas atmosphere or an atmosphere containing C or N, so as to obtain a nano size hyperfine crystalline grain architecture, wherein as a deposition condition an input power density of 4˜8 W/cm², under an N₂ partial pressure of 2˜20%, and a ([C]+[N])/[Hf] composition ratio of 1.5˜2.5 are maintained.

The object and advantages of the present invention will become more readily apparent from the detailed description given hereinafter. However, it should be understood that the detailed description and specific examples, while indicating preferred examples of the invention, are given by way of illustration only, since various changes and modifications within the spirit and scope of the invention will become apparent to those skilled in the art from this detailed description.

### BRIEF DESCRIPTION OF THE DRAWINGS

The present invention will become better understood with reference to the accompanying drawings which are given only by way of illustration and thus are not limitative of the present invention, and wherein:

FIG. 1 is a graph illustrating the variation in saturation magnetic flux density in correspondence to Fe—Hf—(C)—N N₂ partial pressure in materials produced according to the present invention;

FIG. 2 is a graph illustrating the variation in coercivity in correspondence to Fe—Hf—(C)—N N₂ partial pressure in materials produced according to the present invention;

FIG. 3 is a graph illustrating the variation in effective permeability in correspondence to Fe—Hf—(C)—N N₂ partial pressure in materials produced according to the present invention;

FIG. 4 is a graph illustrating the variation in saturation magnetic flux density in correspondence to Fe—Hf—(C)—N input power in materials produced according to the present invention;

FIG. 5 is a graph illustrating the variation in coercivity in correspondence to Fe—Hf—(C)—N input power in materials produced according to the present invention;

FIG. 6 is a graph illustrating the variation in effective permeability in correspondence to Fe—Hf—(C)—N input power in materials produced according to the present invention; and

FIG. 7 is an electron micrograph showing the hyperfine crystalline structure of the Fe—Hf—(C)—N material produced according to the present invention.

### DETAILED DESCRIPTION OF THE INVENTION

The iron-based soft magnetic thin film alloy according to the present invention is formed with a hyperfine crystalline grain structure.

The empirical formula of the hyperfine crystalline grains is as follows:

FeₓHf_{y}C_{z}Nᵥ

wherein x, y, z, v respectively denote atomic %,

68<x≦85

4≦y≦10

0≦z≦12

3≦v≦20

15≦y+z+v≦32

(here, x+y+z+v=100).

In case the structure deviates from the above-described empirical formula and the above-set element ranges, there is not obtained an iron-based soft magnetic thin film alloy providing at the same time a high saturation magnetic flux density, a high magnetic permeability and a heat resistance. This is because compositions other than within the composition ranges described above do not allow a hyperfine crystalline formation required in the iron-based soft magnetic thin film

The Fe—Hf—C—N and Fe—Hf—N soft magnetic thin film alloy according to the present invention can be obtained by the following production process. A soft magnetic thin film alloy according to the present invention may be produced using a sputtering method or by other physical vapor deposition methods.

A preparation process implementing the sputtering method will now be explained.

On a pure iron target, a Fe—Hf alloy target or a Fe—Hf—C alloy target within a sputtering apparatus, there are disposed materials such as Hf and C, and then a thin film is formed by sputtering under an atmosphere containing N₂ as an inert sputtering gas.

When the thin film alloy obtained by the sputtering is annealed, it exhibits a value approximating the soft magnetic property prior to the heat treatment, so that it is understood that an improvement in the soft magnetic property by the heat treatment is not obtained. However, considering that a deterioration phenomenon is not witnessed under the heat treatment, there is obtained an excellent thermal stability.

The thin film produced by the sputtering is prepared such that the nitride and carbide of the α-Fe, Hf are formed in nanocrystalline grains under the deposition condition, thereby yielding an excellent soft magnetic property thereof. Also, the thusly formed fine structure has a formation in which the α-Fe crystalline grains are surrounded by the nitride and carbide, thereby exhibiting a much improved high frequency magnetic permeability as compared to other iron-based soft magnetic alloy having the same size crystalline grains.

Therefore, a core condition is that the sputtering should enable nanocrystalline grains to be formed under the accurate element adjustment and deposition.

The iron-based soft magnetic thin film alloy obtained using such a preparation process retains a high magnetic permeability at a high saturation magnetic flux density and a high frequency range in the hundreds of MHz bands.

Also, there does not occur a deterioration in magnetism due to the heat treatment, so that its application is amendable to a significant variety of fields when compared to the conventional soft magnetic thin film materials.

With reference to the following examples, the present invention will now be described in further detail.

### EXAMPLE 1

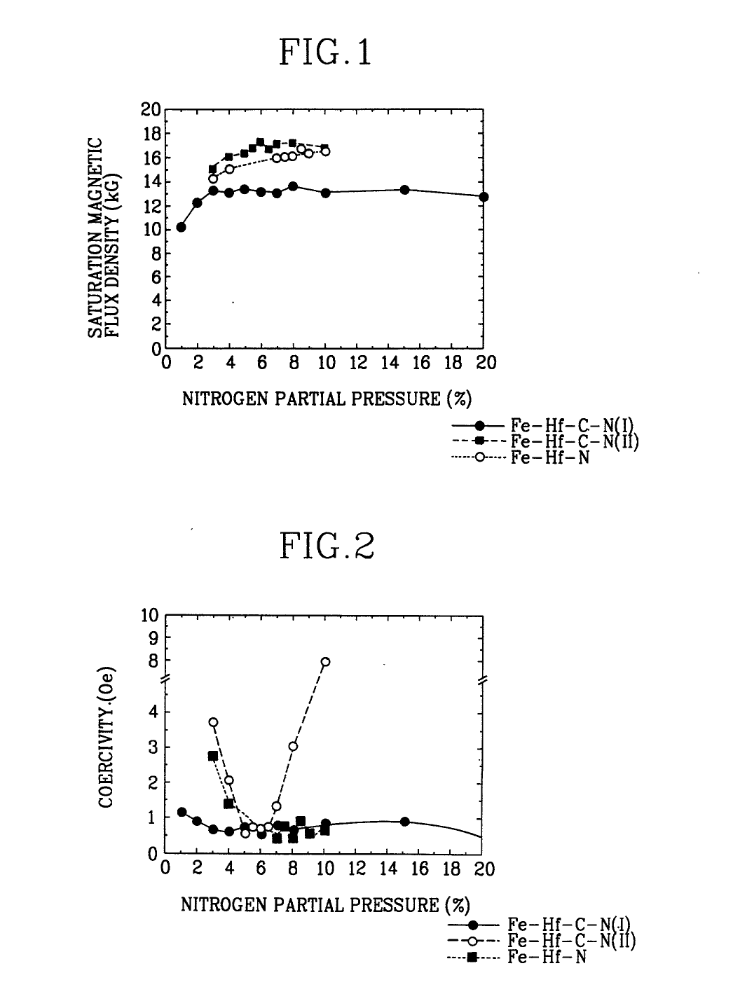

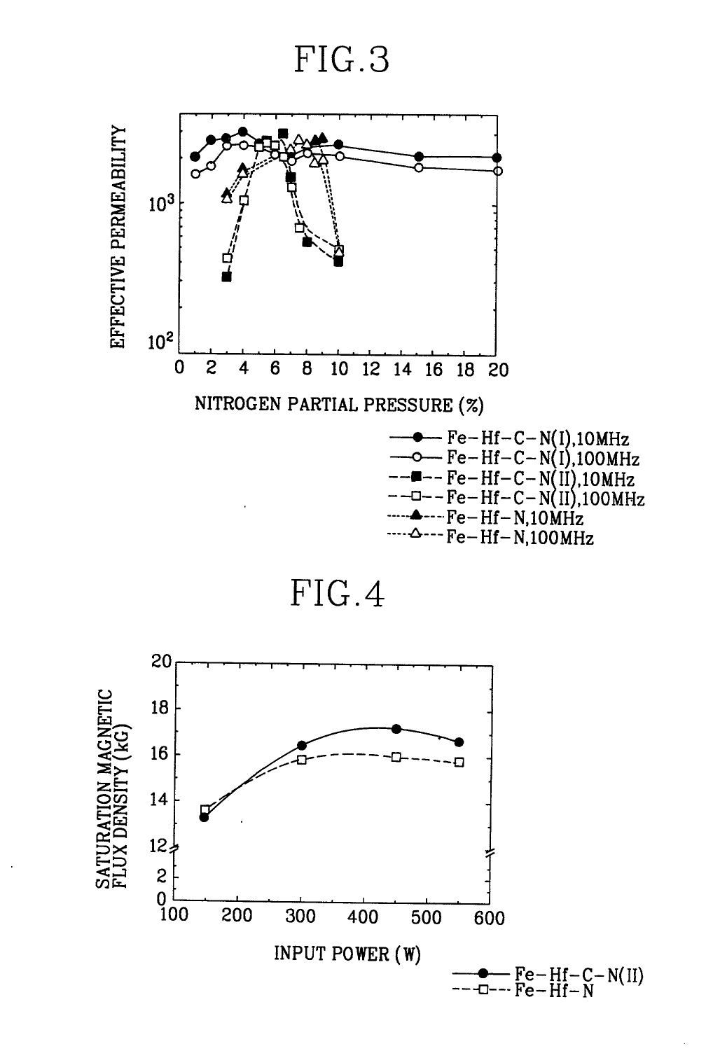

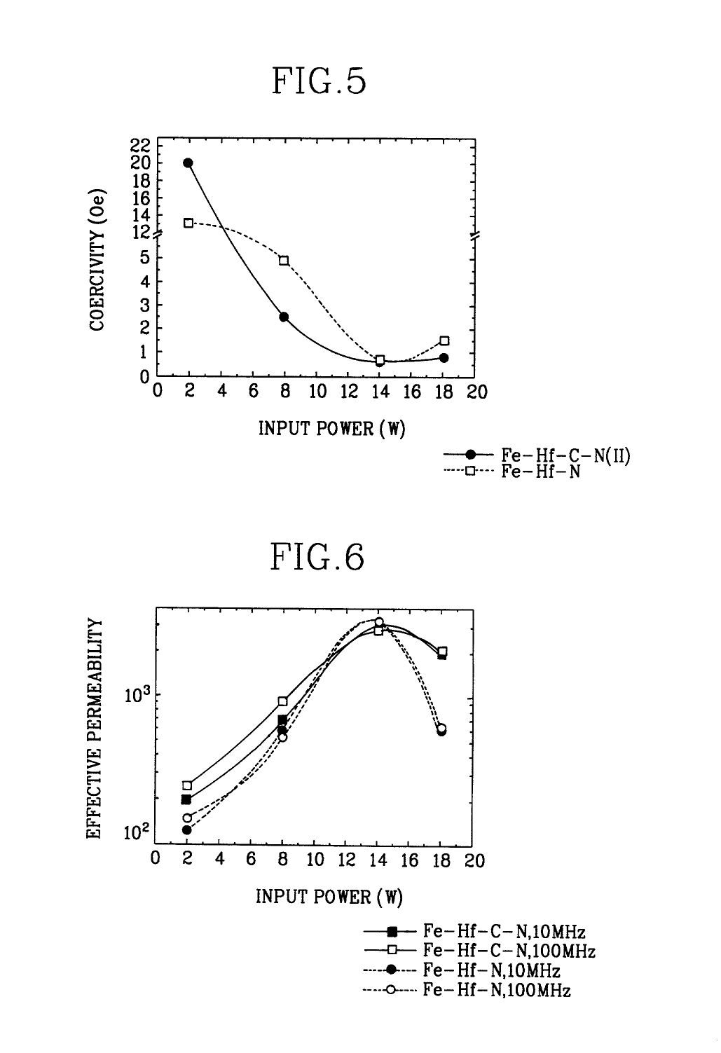

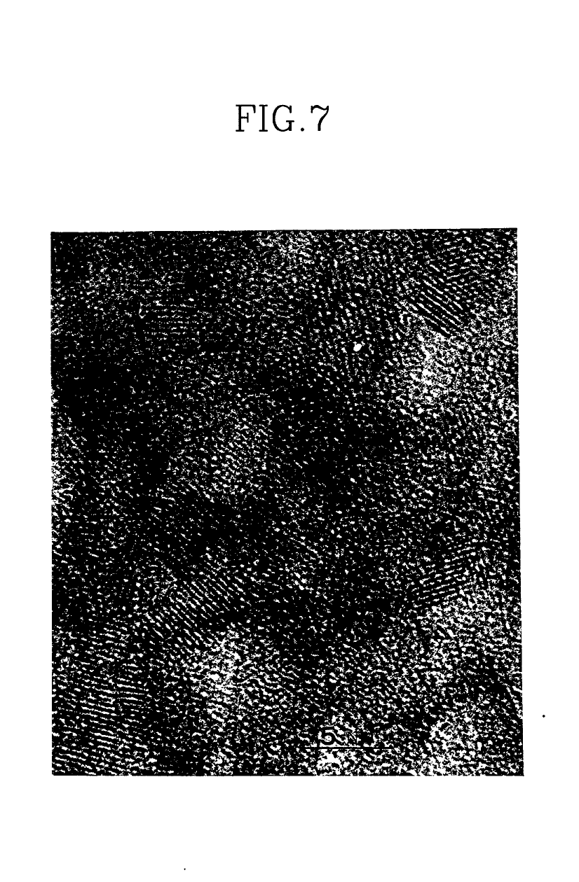

A plurality of different Fe—Hf—C—N thin films were formed having a 1 μm thickness, respectively, using a high frequency bipolar magneto sputtering apparatus. In order to vary the thin film composition, pin-head sized samples of Hf and C were disposed on an Fe target and the composition ratio of Fe, Hf, and C was adjusted by varying the number of the respective samples. A reactive sputtering was carried out while adjusting a flow amount ratio of N₂ and Ar gas being mixed into the N₂ atmosphere. At this time, by adjusting the input power and the N₂ amount of the mixed gas, a nano size hyperfine crystalline grain structure was formed in the deposited state, and the thin films exhibited excellent soft magnetic properties in accordance with the thusly formed hyperfine crystalline grain architecture. In order for the thin films to exhibit a fine structure of nanohyperfine crystalline grains and have excellent soft magnetic properties in the deposited state, there should be maintained an input power density of 4˜8 W/cm², an N₂ quantity of 2˜20%, and a ([C]+[N])/[Hf] composition ratio of 1.5˜2.5. The conditions and magnetic properties of the prepared samples are shown in Table 1. The coercivity in Oe and the saturation magnetic flux density Ms were measured using a vibration sample magnetometer (VSM). Variations in saturation magnetic flux density and coercivity with regard to the partial pressure of N₂ are shown in FIGS. 1 and 2. Variations in effective permeability are shown in FIG. 3. Also, variations in the input power versus saturation magnetic flux density, coercivity and effective permeability are illustrated in FIGS. 4, 5 and 6. In the drawings, Fe—Hf—C—N (I) denotes a thin film, wherein the Fe amount accounts for about 70 atomic %. The deposition state in FIG. 7 is obtained by observing the Fe—Hf—C—N (C) thin film having a hyperfine crystalline architecture using a transmission electron microscope (TEM). In the respective drawings, Fe—Hf—C—N (I) denotes a thin film in which the Fe amount accounts for about 70 atomic %, and Fe—Hf—C—N (II) denotes a thin film in which the Fe amount accounts for about 80 atomic %.

TABLE 1

| | thin film composition | | | | | effective | | | |
|---|---|---|---|---|---|---|---|---|---|
| | (atomic %) | | | | | permeability | | | W/ |
| S | Fe | Hf | C | N | kG | 10 MHz | 100 MHz | Oe | cm² |
| 1 | 80.1 | 8.5 | 3.3 | 8.2 | 15.6 | 3230 | 2090 | 0.50 | 5.7 |
| 2 | 80.5 | 7.8 | 2.8 | 8.9 | 16.1 | 3980 | 3010 | 0.55 | 5.7 |
| 3 | 77.0 | 9.6 | 10.1 | 3.3 | 8.8 | 1670 | 1490 | 1.35 | 5.7 |
| 4 | 74.6 | 9.6 | 10.2 | 5.9 | 10.7 | 1880 | 1870 | 0.88 | 5.7 |
| 5 | 72.2 | 9.1 | 10.6 | 8.1 | 14.0 | 2430 | 2270 | 0.31 | 5.7 |
| 6 | 71.2 | 9.5 | 10.3 | 9.0 | 13.0 | 2940 | 2720 | 0.47 | 5.7 |
| 7 | 70.9 | 8.6 | 9.7 | 10.8 | 13.2 | 3490 | 2940 | 0.42 | 5.7 |
| 8 | 69.1 | 8.7 | 10.6 | 11.6 | 13.2 | 2890 | 2480 | 0.36 | 5.7 |
| 9 | 69.5 | 8.1 | 10.0 | 12.3 | 12.1 | 2570 | 2400 | 0.48 | 5.7 |
| 10 | 71.5 | 8.5 | 8.6 | 11.1 | 13.8 | 2730 | 2600 | 0.50 | 5.7 |
| 11 | 69.0 | 8.3 | 9.9 | 12.8 | 13.2 | 2240 | 2230 | 0.7 | 5.7 |
| 12 | 70.6 | 6.9 | 8.7 | 13.8 | 13.4 | 2500 | 2510 | 1.0 | 5.7 |
| 13 | 69.1 | 5.7 | 7.5 | 17.7 | 12.0 | 2270 | 1740 | 0.1 | 5.7 |
| 14 | 84.8 | 6.9 | 2.0 | 6.3 | 15.1 | 350 | 480 | 3.7 | 5.7 |
| 15 | 81.6 | 6.5 | 2.6 | 9.3 | 15.7 | 1370 | 1450 | 1.18 | 5.7 |
| 16 | 80.1 | 7.1 | 2.7 | 10.1 | 16.4 | 2970 | 2970 | 0.56 | 5.7 |
| 17 | 79.8 | 6.9 | 2.5 | 10.8 | 17.3 | 3010 | 2800 | 0.69 | 5.7 |
| 18 | 81.0 | 5.5 | 2.0 | 11.5 | 17.1 | 2490 | 1730 | 1.15 | 5.7 |
| 19 | 80.9 | 6.0 | 2.4 | 10.7 | 17.3 | 1540 | 1420 | 1.5 | 5.7 |
| 20 | 81.1 | 6.8 | 2.3 | 9.8 | 17.6 | 3660 | 2510 | 0.75 | 5.7 |
| 21 | 80.0 | 7.2 | 2.0 | 10.8 | 16.8 | 3290 | 3160 | 0.73 | 5.7 |
| 22 | 80.4 | 5.6 | 2.0 | 12.0 | 16.6 | 1010 | 1160 | 2.09 | 5.7 |
| 23 | 80.8 | 4.7 | 1.8 | 12.7 | | 200 | 300 | | 1.9 |
| 24 | 80.0 | 6.3 | 1.6 | 12.1 | 17.0 | 600 | 790 | 3.2 | 3.8 |
| 25 | 79.8 | 6.9 | 2.5 | 10.8 | 17.3 | 3010 | 2800 | 0.7 | 5.7 |
| 26 | 80.2 | 6.9 | 2.4 | 10.5 | 16.5 | 2820 | 2980 | 0.7 | 7 |

wherein, S denotes the sample number, kG denotes the saturation magnetic flux density, Oe denotes the coercivity, and W/cm² denotes the input power density.

### EXAMPLE 2

A plurality of different Fe—Hf—C—N thin films were formed to have a 1 μm thickness, respectively, using a high frequency bipolar magneto sputtering apparatus. In order to vary the thin film composition, pin-head sized samples of Hf and C were disposed on an Fe target and the composition ratio of Fe, and Hf was adjusted by varying the number of Hf samples. A reactive sputtering was carried out while adjusting a flow amount ratio of N₂ and Ar gas being mixed into the N₂ atmosphere. By varying the input power and the N₂ amount of the mixed gas, a fine structure of the deposited thin films was varied with strongly influenced the soft magnetic properties in accordance therewith. In order for the deposited thin films to exhibit a fine structure of nanohyperfine crystalline grains and have excellent soft magnetic properties, there should be maintained an input power density of 4˜8 W/cm², an N₂ quantity of 6˜10%, and a [N]/[Hf] composition ratio of 1.5˜2.5. The conditions and magnetic properties of the prepared samples are shown in Table 2. Variations in saturation magnetic flux density and coercivity with regard to the partial pressure of N₂ are shown in FIGS. 1 and 2. Variations in effective permeability are shown in FIG. 3. Also, variations in the input power versus saturation magnetic flux density, coercivity and effective permeability are illustrated in FIGS. 4, 5 and 6. In the drawings, Fe—Hf—C—N (II) denotes a thin film in which the Fe amount accounts for about 80 atomic %.

TABLE 2

| | thin film composition | | | | effective | | | |
|---|---|---|---|---|---|---|---|---|
| | (atomic %) | | | | permeability | | | |
| S | Fe | Hf | N | kG | 10 MHz | 100 MHz | Oe | W |
| 1 | 82.1 | 7.3 | 10.6 | 14.3 | 1370 | 1250 | 2.8 | 450 |
| 2 | 78.9 | 4.2 | 13.9 | 15.5 | 2040 | 1880 | 1.3 | 450 |
| 3 | 80.1 | 7.3 | 12.6 | 16.5 | 2720 | 2750 | 0.4 | 450 |
| 4 | 80.6 | 6.0 | 13.4 | 16.4 | 3090 | 3250 | 0.7 | 450 |
| 5 | 79.0 | 7.0 | 14.0 | 16.2 | 3040 | 3060 | 0.4 | 450 |
| 6 | 80.5 | 6.3 | 13.2 | 16.5 | 3240 | 2240 | 0.9 | 450 |
| 7 | 80.0 | 6.4 | 13.6 | 16.4 | 2380 | 1690 | 0.6 | 450 |
| 8 | 78.7 | 5.9 | 15.4 | 16.6 | 1210 | 1200 | 1.5 | 450 |
| 9 | 78.1 | 4.1 | 17.8 | 14.0 | 300 | 150 | 13.0 | 150 |
| 10 | 79.9 | 6.0 | 14.1 | 16.0 | 590 | 530 | 6.0 | 300 |
| 11 | 80.6 | 6.0 | 13.4 | 16.4 | 3180 | 3250 | 0.7 | 450 |
| 12 | 79.0 | 7.5 | 13.5 | 16.0 | 1570 | 1690 | 0.9 | 550 |

wherein, S denotes the sample number, kG denotes the saturation magnetic flux density, Oe denotes the coercivity, and W denotes the supplied power.

From the results for examples 1 and 2, it can be understood that without a heat treatment process, there are obtained Fe—Hf—C—N and Fe—Hf—N thin film alloys having a high effective permeability and excellent heat resistance even under a comparatively high saturation magnetic flux density (13˜17.5 kG) and at a high frequency.

### Comparative Example 1

Using an Fe—Hf alloy target and high frequency sputtering under an Ar atmosphere containing nitrogen, an Fe—Hf—N thin film was deposited and annealed, exhibiting excellent properties. The magnetic properties as disclosed in Japanese Laid-Open Patent Publication No. 2-275605 were as follows.

TABLE 3
4/29 Property Variations according to Comparative Example 1

| | TFC (atomic %) | | | | | | |
|---|---|---|---|---|---|---|---|
| SA | Fe | Hf | N | HT(° C.) | kG | Pe | Oe |
| 1 | 81.3 | 7.5 | 11.2 | 550 | 16.3 | — | 2.0 |
| 2 | 74.6 | 10.9 | 14.5 | 550 | 13.6 | — | 0.85 |

wherein, SA denotes the sample number, TFC denotes the thin film composition, HT denotes the heat treatment temperature, kG denotes the saturation magnetic flux density, Pe denotes the magnetic permeability, and Oe denotes the coercivity.

### Comparative Example 2

Samples of Hf and C were disposed on Fe target, or Hf was disposed on the Fe target to be sputtered under an Ar+CH₄ atmosphere for thereby preparing a Fe—Hf—C thin film. The magnetic properties as disclosed in Japanese Laid-Open Patent Publication No. 2-20444 were as follows.

TABLE 4
Property Variations according to Comparative Example 2

| | TFC (atomic %) | | | | | | |
|---|---|---|---|---|---|---|---|
| SA | Fe | Hf | N | HT (° C.) | kG | Pe(5 MHz) | Oe |
| 1 | 81.3 | 7.5 | 11.2 | 550 | 15.6 | 1790 | — |
| | | | | 550 | 15.6 | 1100 | — |

wherein, SA denotes the sample number, TFC denotes the thin film composition, HT denotes the heat treatment temperatures, kG denotes saturation magnetic flux density, Pe denotes the magnetic permeability, and Oe denotes the coercivity.

### Comparative Example 3

Pin-head sized samples of Hf and C were disposed on a Fe target, and a reactive sputtering was carried out with an input power of 300 W and under a mixed gas of Ar and N₂ total pressure to form a Fe—Hf—C—N thin film. The magnetic properties as disclosed in Korean Patent Publication No. 96-4664 were as follows.

TABLE 5
Property Variations according to Comparative Example 3

| | TFC (atomic %) | | | | HT | | EP | | |
|---|---|---|---|---|---|---|---|---|---|
| SA | Fe | Hf | C | N | (° C.) | kG | 1 MHz | 5 MHz | Oe |
| 1 | 71.4 | 10.7 | 4.7 | 13.2 | 550 | 14.8 | 2780 | 2720 | 0.18 |
| | | | | | 650 | 15.2 | 2070 | 2020 | 0.27 |
| 2 | 80.7 | 6.7 | 6.4 | 6.2 | 550 | 17.1 | 6310 | 6160 | 0.17 |
| | | | | | 650 | 17.5 | 4990 | 4840 | 0.32 |

wherein, SA denotes the sample number, TFC denotes the thin film composition, HT denote the heat treatment temperature, kG denotes the saturation magnetic flux density, EP denotes the effective permeability, and Oe denotes the coercivity.

As described above, the iron-based hyperfine crystalline structure according to the above comparative examples requires a heat treatment process and a high effective permeability is obtained in the frequency region below 10 MHz.

However, according to the examples given previously, the present invention realizes excellent soft magnetic properties without needing a heat treatment process. Further, the permeability does not exhibit any decrease and remains at a 2000˜3000 value in the high frequency region up to 100 MHz, thereby realizing excellent soft magnetic properties.

As the present invention may be embodied in several forms without departing from the spirit of essential characteristics thereof, it should also be understood that the above-described examples are not limited by any of the details of the foregoing description, unless otherwise specified, but rather should be construed broadly within its spirit and scope as defined in the appended claims, and therefore all changes and modifications with regard to a variety of preparation methods of nano size hyperfine crystalline grains under the thin film composition and deposition conditions that fall within the meets and bounds of the claims, or equivalences of such meets and bounds, are therefore intended to be embraced by the appended claims.

What is claimed is:

1. An iron-based soft magnetic thin film alloy, having an empirical formula of FeₓHf_{y}C_{z}Nᵥ (where x, y, z, and v respectively denote atomic %, 68≦x≦85, 4≦y≦10, 0≦z≦12, 3≦v≦20, 15≦y+z+v≦32, and x+y+z+v=100), and having a fine structure formed of nano size crystalline grains including nitrides or carbides of α-Fe and Hf.

2. A method for preparation of an iron-based soft magnetic thin film alloy having a hyperfine crystalline grain architecture in a deposited state without requiring a heat treatment process, comprising the steps of:
disposing Hf, nitrides and carbides of Hf, and C on a pure iron alloy, an Fe—Hf alloy, or Fe—Hf—C alloy target;
performing a deposition by adjusting a cooling rate and particle energy under an inert gas atmosphere or an atmosphere containing C or N, so as to obtain a nano size hyperfine crystalline grain architecture, wherein as a deposition condition an input power density of 4˜8 W/cm², under an N₂ partial pressure of 2˜20%, and a ([C]+[N])/[Hf] composition ratio of 1.5˜2.5 are maintained.
